(19) United States
(12) Patent Application Publication
(10) Pub. No.: US 2009/0139384 A1
(43) Pub. Date: Jun. 4, 2009

(54) INDEX FINGER MOUNTED GUITAR PICK

(76) Inventor: Robert Bramucci, Tustin, CA (US)

Correspondence Address: BELASCO, JACOBS & TOWNSLEY LLP;HOWARD HUGHES CENTER, 6701 CENTER DRIVE, 14th Floor, LOS ANGELES, CA, 90045, US

(21) Appl. No.: 11/947,110

(22) Filed: Nov. 29, 2007

(51) Int. Cl. G10D 3/16

(52) U.S. Cl. 84/322

(57) ABSTRACT

An index finger mounted guitar pick has first and second parallel, planar surfaces, an upper end and a lower, string-engaging end and is formed of resilient material. A mounting ring is sized and shaped to fit about an index finger of a guitarist and is attached orthogonally to one of the planar surfaces. The mounting ring is positioned at a point spaced downwardly from the upper end. The mounting ring is fixedly or rotatably attached to one of the planar surfaces and is adjustable for different sized fingers. A slot penetrates the planar surfaces and extends from a point spaced downwardly from the upper end toward the lower end. A fastener has a front element attached to the mounting ring, a bearing element located in the slot and a rear element. The fastener is fitted frictionally to the slot, providing adjustable positioning of the mounting ring on the guitar pick.

### FIELD OF INVENTION

This invention relates to the field of devices used in playing musical instruments, and more specifically to a guitar pick mounted to a guitar player's index finger.

### BACKGROUND OF THE INVENTION

Musicians that play guitar generally do so in two fashions. The first involves picking the guitar strings with the tips of the fingers and the second involves use of a rigid or semi-rigid guitar pick held between or attached to a finger or fingers. Some guitarists prefer to play using both techniques during the same performance. This raises the problem of what to do with the pick while picking with the fingers. Common solutions include adhesives to stick one or more picks to a microphone stand, holding the pick in the palm with the thumb, and various pick attachment means. None of these solutions are particularly satisfactory as it becomes difficult to get the pick into action and then store it again within the short intervals of time available during a musical performance. Using some of the prior art methods, the pick is easily lost or dropped in the heat of performance. The present invention provides practical, easy to use solutions to this long-felt problem.

U.S. Pat. No. 4,497,237, issued to Beall, discloses a two-piece band that is attached to a conventional flat stringed instrument pick allowing it to be held on a finger and without engaging the finger too firmly. This band allows the pick to be used for strumming or allows it to be moved out of the way for finger picking. Each side of the conventional pick has a pad glued in place, the pads are adapted to be gripped by the thumb and finger of the player. Each of the pads has a groove adapted to receive and hold an end of the band portions. The band is preferably constructed from a coated wire such as a chenille stem. The ends of the band portions are bent to be angularly disposed relative to one another meeting at a juncture. The player's finger is inserted in the loop formed between the two bands and the ends can be adjusted to achieve a snug but comfortable fit.

U.S. Pat. No. 6,977,330, issued to Santa Cruz et al is directed to a finger ring and pick apparatus that allows a musician to easily use the pick while playing but it is non-intrusive when the pick is not being used. The finger ring may be formed into a complete circle and sized to fit or it may be open so as to be adjustable. The finger ring is attached to a tether. The tether can be simply tied to the finger ring or in an alternate embodiment the finger ring might have a retractable mechanism that allows a desired amount of tether to be played out and locked by the mechanism. The end of the tether is secured to a standard pick by means of an attachment device or it can be tied to the pick through an aperture.

U.S. Pat. No. 5,837,913, issued to Newman is directed to several embodiments of a plectrum holder that attaches to a user's hand so that the musician can easily go back and forth between finger plucking or plectrum plucking. The apparatus consists of a hand engaging means that may comprise a continuous loop or ring that is the size and shape for the musician's finger. The hand engaging means may be a discontinuous loop of any material. It may be a strip that is looped onto itself so as to form a ring and held by any of known fabric fasteners such as buttons, snaps, hooks, Velcro®-type material or adhesives. Hand engaging means is connected to a resilient member that may be a light coil tension spring. Rather than the resilient spring member a spring biased reel with a tether line or filament may be used. A plectrum is fastened to the resilient element or the tether by means of a binding element that may be formed from a polymer metal elastomeric compound or fabric.

U.S. Pat. No. 6,797,871, issued to Atkin disclose a stringed instrument strumming/picking apparatus. The apparatus comprises a sleeve adapted to engage the finger of a player. The sleeve has a loop Velcro pad attached to it. A pick with a hook Velcro pad attached to it can be positioned, extended, retracted or at any desired angle and easily reattached as desired. Changes in playing style as well as guitar orientation may require adjustments in the angle of the pick relative to the thumb. An additional embodiment to facilitate this change in angle provides a pad that is wedge shaped to facilitate angle variation. The pad has a Velcro hook pad on one surface and a self-stick surface for attaching to the pick on the other side. The pivot pad can be provided in many different configurations and shapes as well as being non-planar.

U.S. Pat. No. 5,842,247, issued to Decesare is directed to a combination toothbrush and tongue brush. The tongue brush portion includes a curvilinear shaft integrally coupled with the second end of the main body portion of the device. The combination toothbrush and tongue brush also includes a plurality of gripping ridges which are integrally formed and extend upwardly from an exterior surface of the main body portion intermediate first and second ends of the device.

U.S. Pat. No. D397,718, issued to Mulkins discloses an ornamental design for a musical instrument pick holder as shown in FIGS. 1 and 2. The design appears to be a resilient plastic material with a finger ring and tether as a unitary mold with the far end of the tether engaged in an aperture in a pick. It does not disclose a single, non-rotating resilient or adjustable loop attached to one side surface of the pick. As this reference does not disclose the limitations of the present invention, we believe that it can be distinguished from Mulkins.

It is an objective of the present invention to provide a plectrum that is convenient and easy to use and that permits the guitarist to switch easily to finger picking in a single piece of music. It is a further objective to provide such a device that is easily attached to the index finger of the guitarist. It is yet a further objective to provide a pick that is not easily lost while finger picking. Finally, it is an objective of the present invention to provide a pick that does not interfere with finger picking while be readily available for plectrum use.

While some of the objectives of the present invention are disclosed in the prior art, none of the inventions found include all of the requirements identified.

### SUMMARY OF THE INVENTION

The present invention addresses all of the deficiencies of prior art index finger mounted guitar pick inventions and satisfies all of the objectives described above.

(1) An index finger mounted guitar pick may be constructed from the following components. A guitar pick is provided. The pick has first and second parallel, planar surfaces, an upper end and a lower, string-engaging end and is formed of resilient material. A mounting ring is provided. The mounting ring is sized and shaped to fit about an index finger of a guitarist and is attached orthogonally to either of the first and second planar surfaces. The mounting ring is positioned at least one point spaced downwardly from the upper end.

(2) In a variant of the invention, the mounting ring is fixedly attached to either of the first and second planar surfaces.

(3) In another variant, the mounting ring is rotatably attached to either of the first and second planar surfaces.

(4) In yet another variant, the mounting ring is adjustable for different sized fingers.

(5) In still another variant, the mounting ring comprises hooking elements and looping elements, the elements providing size adjustment.

(6) In a further variant, the mounting ring comprises a first portion and a second portion, the first and second portions have at least two pair of mating snap elements affixed to inner and outer surfaces of the first and second portions, respectively.

(7) In still a further variant, the mounting ring includes a serrated tongue portion and a mating buckle portion. The tongue portion provides a plurality of size adjustments and the buckle portion secures attachment to the tongue portion.

(8) In another variant of the invention, the mounting ring is formed of an elastic material to accommodate different sized fingers.

(9) In still another variant, a slot is provided. The slot penetrates the first and second planar surfaces of the guitar pick and extends from a point spaced inwardly from a first point on a perimeter of said pick to a second point spaced inwardly from said perimeter; A fastener is provided. The fastener has a front element, a bearing element and a rear element. The front element is attached to the mounting ring and located on the first planar surface. The bearing element is attached to the front element and located within the slot. The rear element is attached to the bearing element and located on the second planar surface. The fastener is fitted frictionally to the slot, thereby providing adjustable positioning of the mounting ring on the guitar pick.

(10) In yet another variant, at least one of the front element and the rear element is removably attached to the bearing element with a screw thread, thereby permitting the fastener to be tightened in the slot.

(11) In a further variant, the mounting ring is rotatably attached to the front element.

(12) In still a further variant, the slot is X-shaped and has first and second intersecting portions. The first portion extends from a point spaced downwardly from a first side of the upper end toward a second side of the lower, string-engaging end. The second portion extends from a point spaced downwardly from a second side of the upper end toward a first side of the lower, string-engaging end.

(13) In yet a further variant, the slot is V-shaped and has a first and second intersecting sections. The first section extends from a point spaced downwardly from a first side of the upper end toward a center portion of the lower, string-engaging end. The second section extends from a point spaced downwardly from a second side of the upper end toward the center portion of the lower, string-engaging end.

(14) In a final variant of the invention, the slot is Y-shaped and has a first and second intersecting arms and a stem. The first arm extends from a point spaced downwardly from a first side of the upper end toward a mid point and the second arm extends from a point spaced downwardly from a second side of the upper end toward the mid point. The stem extends from the mid point toward the lower, string-engaging end.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention as stowed during guitar playing with finger picking;

FIG. 1A is a perspective view of the preferred embodiment of the invention as used during guitar playing with the pick;

FIG. 2 is a perspective view of the FIG. 1 embodiment illustrating attachment of the mounting ring;

FIG. 3 is a perspective view of a second embodiment having a rotatably mounted ring;

FIG. 4 is a perspective view of a third embodiment having a mounting ring adjustable through hooking and looping elements;

FIG. 5 is a perspective view of a fourth embodiment having a mounting ring adjustable through snaps;

FIG. 6 is a perspective view of a fifth embodiment having an elastic mounting ring for adjustable fit;

FIG. 7 is a perspective view of a sixth embodiment having a mounting ring adjustable through a belt and buckle arrangement;

FIG. 8 is a perspective view of a seventh embodiment having a vertical slot for adjusting the ring mounting position;

FIG. 9 is a cross-sectional side view of the FIG. 8 embodiment adding a screw tightening mechanism for controlling the mounting ring position;

FIG. 10 is a perspective view of the FIG. 8 embodiment adding a rotatable mounting for the ring;

FIG. 11 is a perspective view of an eighth embodiment having an X-shaped slot for adjusting the ring mounting position;

FIG. 12 is a perspective view of a ninth embodiment having an Y-shaped slot for adjusting the ring mounting position; and

FIG. 13 is a perspective view of a tenth embodiment having an V-shaped slot for adjusting the ring mounting position.

### DETAILED DESCRIPTION OF THE PREFERRED EMBODIMENT

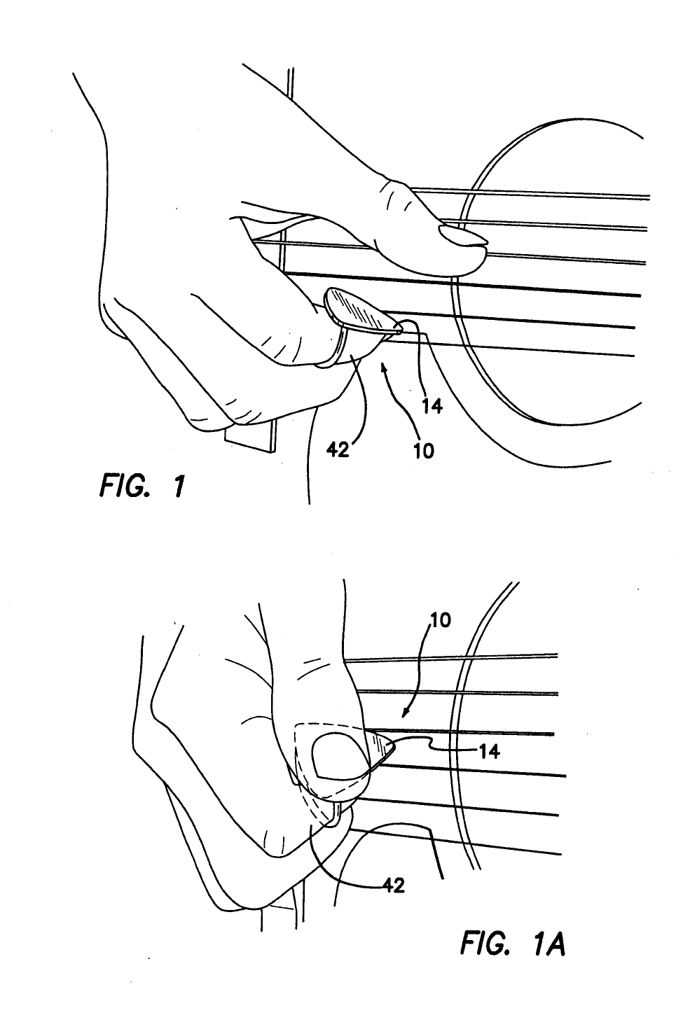

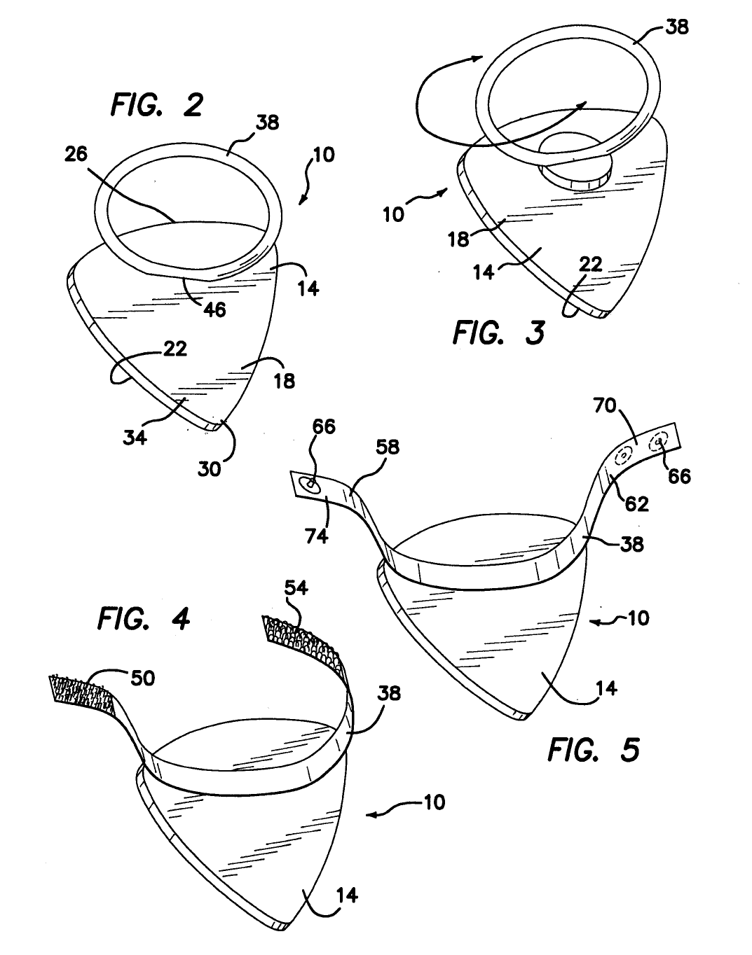

(1) FIGS. 1-13 illustrate an index finger mounted guitar pick 10 that may be constructed from the following components. A guitar pick 14 is provided. The pick 14, as illustrated in FIGS. 1, 1A and 2, has first 18 and second 22 parallel, planar surfaces, an upper end 26 and a lower, string-engaging end 30 and is formed of resilient material 34. A mounting ring 38 is provided. The mounting ring 38 is sized and shaped to fit about an index finger of a guitarist 42 and is attached orthogonally to either of the first 18 and second 22 planar surfaces. The mounting ring 38 is positioned at least one point 46 spaced downwardly from the upper end 26.

(2) In a variant of the invention, as illustrated in FIG. 2, the mounting ring 38 is fixedly attached to either of the first 18 and second 22 planar surfaces.

(3) In another variant, as illustrated in FIG. 3, the mounting ring 38 is rotatably attached to either of the first 18 and second 22 planar surfaces.

(4) In yet another variant, as illustrated in FIGS. 4-7, the mounting ring 38 is adjustable for different sized fingers 42.

(5) In still another variant, as illustrated in FIG. 4, the mounting ring 38 comprises hooking elements 50 and looping elements 54, the elements 50, 54 providing size adjustment.

(6) In a further variant, as illustrated in FIG. 5, the mounting ring 38 comprises a first portion 58 and a second portion 62, the first 58 and second 62 portions have at least two pair of mating snap elements 66 affixed to inner 70 and outer 74 surfaces of the first 58 and second 62 portions, respectively.

(7) In still a further variant, as illustrated in FIG. 7, the mounting ring 38 includes a serrated tongue portion 78 and a mating buckle portion 82. The tongue portion 78 provides a plurality of size adjustments 86 and the buckle portion 82 secures attachment to the tongue portion 78.

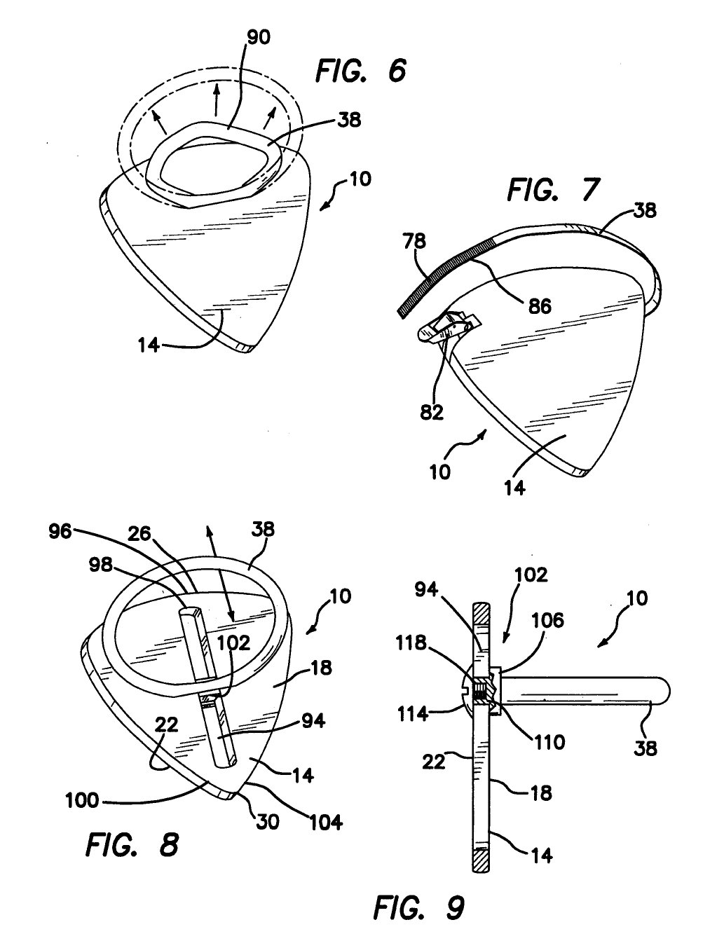

(8) In another variant of the invention, as illustrated in FIG. 6, the mounting ring 38 is formed of an elastic material 90 to accommodate different sized fingers 42.

(9) In still another variant, as illustrated in FIGS. 8 and 9, a slot 94 is provided. The slot 94 penetrates the first 18 and second 22 planar surfaces of the guitar pick 14 and extends from a point 98 spaced inwardly from a first point 96 on a perimeter 100 of said pick to a second point 104 spaced inwardly from said perimeter. A fastener 102 is provided. The fastener 102 has a front element 106, a bearing element 110 and a rear element 114. The front element 106 is attached to the mounting ring 38 and located on the first planar surface 18. The bearing element 110 is attached to the front element 106 and located within the slot 94. The rear element 114 is attached to the bearing element 110 and located on the second planar surface 22. The fastener 102 is fitted frictionally to the slot 94, thereby providing adjustable positioning of the mounting ring 38 on the guitar pick 14.

(10) In yet another variant, as illustrated in FIG. 9, at least one of the front element 106 and the rear element 114 is removably attached to the bearing element 110 with a screw thread 118, thereby permitting the fastener 102 to be tightened in the slot 94.

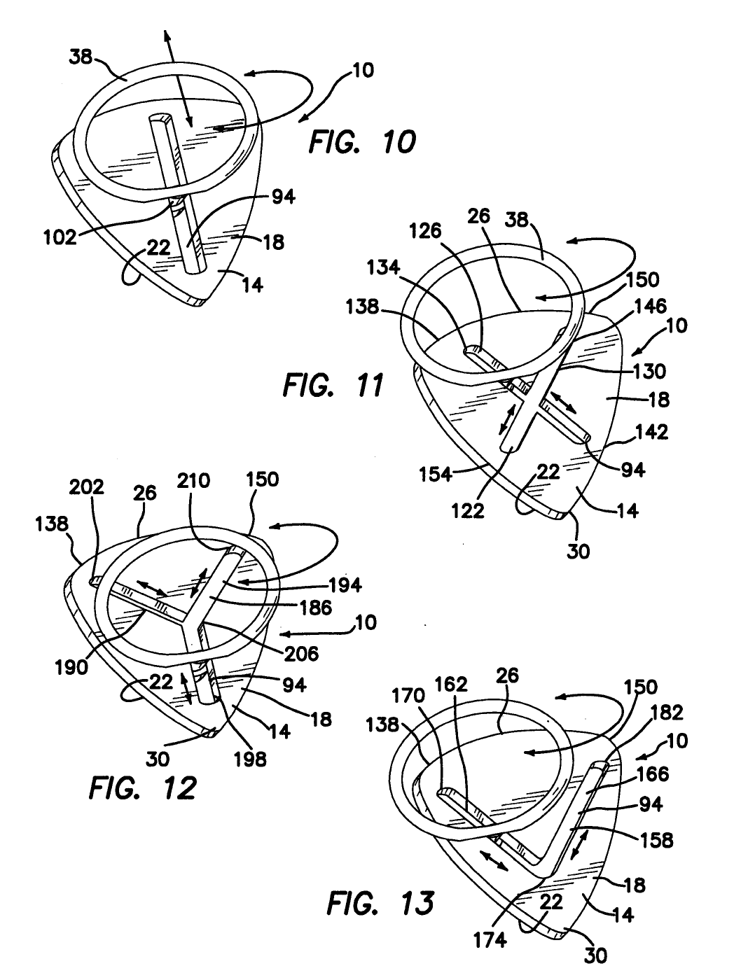

(11) In a further variant, as illustrated in FIG. 10, the mounting ring 38 is rotatably attached to the front element 106.

(12) In still a further variant, as illustrated in FIG. 11, the slot 94 is X-shaped 122 and has first 126 and second 130 intersecting portions. The first portion 126 extends from a point 134 spaced downwardly from a first side 138 of the upper end 26 toward a second side 142 of the lower, string-engaging end 30. The second portion 130 extends from a point 146 spaced downwardly from a second side 150 of the upper end 26 toward a first side 154 of the lower, string-engaging end 30.

(13) In yet a further variant, as illustrated in FIG. 13, the slot 94 is V-shaped 158 and has a first 162 and second 166 intersecting sections. The first section 162 extends from a point 170 spaced downwardly from a first side 138 of the upper end 26 toward a center portion 174 of the lower, string-engaging end 30. The second section 166 extends from a point 182 spaced downwardly from a second side 150 of the upper end 26 toward the center portion 174 of the lower, string-engaging end 30.

(14) In a final variant of the invention, as illustrated in FIG. 12, the slot 94 is Y-shaped 186 and has a first 190 and second 194 intersecting arms and a stem 198. The first arm 190 extends from a point 202 spaced downwardly from a first side 138 of the upper end 26 toward a mid point 206 and the second arm 194 extends from a point 210 spaced downwardly from a second side of 150 the upper end 26 toward the mid point 206. The stem 198 extends from the mid point 206 toward the lower, string-engaging end 30.

The index finger mounted guitar pick 10 has been described with reference to particular embodiments. Other modifications and enhancements can be made without departing from the spirit and scope of the claims that follow.

1. An index finger mounted guitar pick, comprising:
a guitar pick, said pick having first and second parallel, planar surfaces, an upper end and a lower, string-engaging end and being formed of resilient material;
a mounting ring, said mounting ring being sized and shaped to fit about an index finger of a guitarist and being attached orthogonally to either of said first and second planar surfaces; and
said mounting ring being positioned at least one point spaced downwardly from said upper end.

2. The index finger mounted guitar pick, as described in claim 1, wherein said mounting ring is fixedly attached to either of said first and second planar surfaces.

3. The index finger mounted guitar pick, as described in claim 1, wherein said mounting ring is rotatably attached to either of said first and second planar surfaces.

4. The index finger mounted guitar pick, as described in claim 1, wherein said mounting ring is adjustable for different sized fingers.

5. The index finger mounted guitar pick, as described in claim 4, wherein said mounting ring comprises hooking elements and looping elements, said elements providing size adjustment.

6. The index finger mounted guitar pick, as described in claim 4, wherein said mounting ring comprises a first portion and a second portion, said first and second portions having at least two pair of mating snap elements affixed to inner and outer surfaces of said first and second portions, respectively.

7. The index finger mounted guitar pick, as described in claim 4, wherein said mounting ring comprises a serrated tongue portion and a mating buckle portion, said tongue portion providing a plurality of size adjustments and said buckle portion securing attachment to said tongue portion.

8. The index finger mounted guitar pick, as described in claim 4, wherein said mounting ring is formed of an elastic material to accommodate different sized fingers.

9. The index finger mounted guitar pick, as described in claim 1, further comprising:
a slot, said slot penetrating said first and second planar surfaces of said guitar pick and extending from a point spaced inwardly from a first point on a perimeter of said pick to a second point spaced inwardly from said perimeter;
a fastener, said fastener having a front element, a bearing element and a rear element, said front element being attached to said mounting ring and disposed upon said first planar surface, said bearing element being attached to said front element and disposed within said slot, said rear element being attached to said bearing element and disposed upon said second planar surface;
said fastener being fitted frictionally to said slot, thereby providing adjustable positioning of said mounting ring on said guitar pick.

10. The index finger mounted guitar pick, as described in claim 9, wherein at least one of said front element and said rear element is removably attached to said bearing element with a screw thread, thereby permitting said fastener to be tightened in said slot.

11. The index finger mounted guitar pick, as described in claim 9, wherein said mounting ring is rotatably attached to said front element.

12. The index finger mounted guitar pick, as described in claim 9, wherein said slot is X-shaped, having first and second intersecting portions, said first portion extending from a point spaced downwardly from a first side of said upper end toward a second side of said lower, string-engaging end and said second portion extending from a point spaced downwardly from a second side of said upper end toward a first side of said lower, string-engaging end.

13. The index finger mounted guitar pick, as described in claim 9, wherein said slot is V-shaped, having a first and second intersecting sections, said first section extending from a point spaced downwardly from a first side of said upper end toward a center portion of said lower, string-engaging end and said second section extending from a point spaced downwardly from a second side of said upper end toward said center portion of said lower, string-engaging end.

14. The index finger mounted guitar pick, as described in claim 9, wherein said slot is Y-shaped, having a first and second intersecting arms and a stem, said first arm extending from a point spaced downwardly from a first side of said upper end toward a mid point and said second arm extending from a point spaced downwardly from a second side of said upper end toward said mid point, said stem extending from said mid point toward said lower, string-engaging end.
